(19) United States
(12) Patent Application Publication
(10) Pub. No.: US 2013/0298095 A1
(43) Pub. Date: Nov. 7, 2013

(54) METHOD FOR CHECKING I/O CELL CONNECTIONS AND ASSOCIATED COMPUTER READABLE MEDIUM

(71) Applicant: REALTEK SEMICONDUCTOR CORP., HsinChu (TW)

(72) Inventors: Mei-Li Yu, Taoyuan County (TW); Yu-Lan Lo, Hsinchu County (TW); Shu-Yi Kao, Hsinchu County (TW)

(73) Assignee: Realtek Semiconductor Corp., HsinChu (TW)

(21) Appl. No.: 13/875,263

(22) Filed: May 1, 2013

(30) Foreign Application Priority Data
May 7, 2012 (TW) 101116169

(51) Int. Cl. G06F 17/50

(52) U.S. Cl. CPC G06F 17/5081
USPC 716/112

(57) ABSTRACT

A computer readable medium includes a program code for checking whether an I/O cell of a chip design has a connection error or not, where the chip design includes a plurality of I/O cells and a plurality of blocks, and when the program code is executed by a processor, the program code executes following steps: checking a connection between the I/O cell and a block by utilizing a check item corresponding to an attribute of the I/O cell to generate a checking result; and determining whether the I/O cell has a connection error according to the checking result.

### BACKGROUND OF THE INVENTION

1. Field of the Invention

The present invention relates to a chip design, and more particularly, to a method for checking whether I/O (input/output) cells in a chip design have connection errors or not and associated computer readable medium.

2. Description of the Prior Art

In order to check whether I/O devices (i.e. I/O cells and I/O pads) in a chip design have connection errors or not, a static timing analysis (STA) or dynamic analysis is generally used to analyze the functions/operations of the whole chip. If the above analysis tool reports function failed or timing variation, a designer needs to sequentially analyze all the related timing paths to find the reason. However, the designer may waste much time to find the timing paths and to analyze the timing analysis report, and some analysis points may be missed.

### SUMMARY OF THE INVENTION

It is therefore an objective of the present invention to provide a method for checking whether I/O cells in a chip design have connection errors or not, which can quickly report which nodes of I/O cells have connection errors, to solve the above-mentioned problems.

According to one embodiment of the present invention, a computer readable medium comprises a program code for checking whether an I/O cell of a chip design has a connection error or not, where the chip design comprises a plurality of I/O cells and a plurality of blocks, and when the program code is executed by a processor, the program code executes following steps: checking a connection between the I/O cell and a block by utilizing a check item corresponding to an attribute of the I/O cell to generate a checking result; and determining whether the I/O cell has a connection error according to the checking result.

According to another embodiment of the present invention, a method for checking whether an I/O cell of a chip design has a connection error or not is disclosed, where the chip design comprises a plurality of I/O cells and a plurality of blocks, and the method comprises: executing a program code to check a connection between the I/O cell and a block by utilizing a check item corresponding to an attribute of the I/O cell to generate a checking result; and determining whether the I/O cell has a connection error according to the checking result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a diagram illustrating a computer readable medium according to one embodiment of the present invention.

FIG. 1B is a diagram illustrating a chip design.

FIG. 2 is a flowchart of a method for checking whether the I/O cells in a chip design have connection errors or not according to one embodiment of the present invention

FIG. 3 is a diagram showing a cell name check.

FIG. 4 is a diagram showing a pin name check.

### DETAILED DESCRIPTION

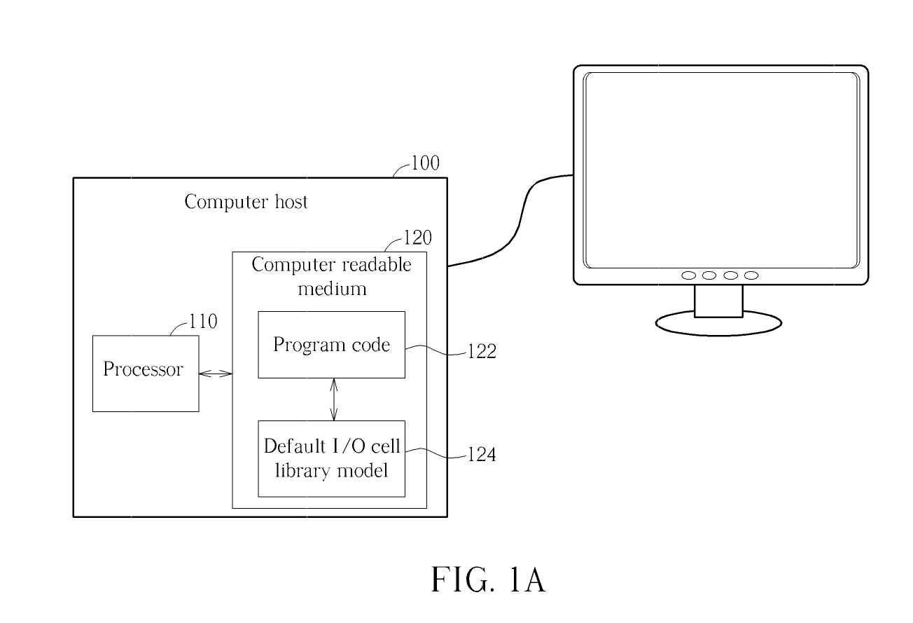

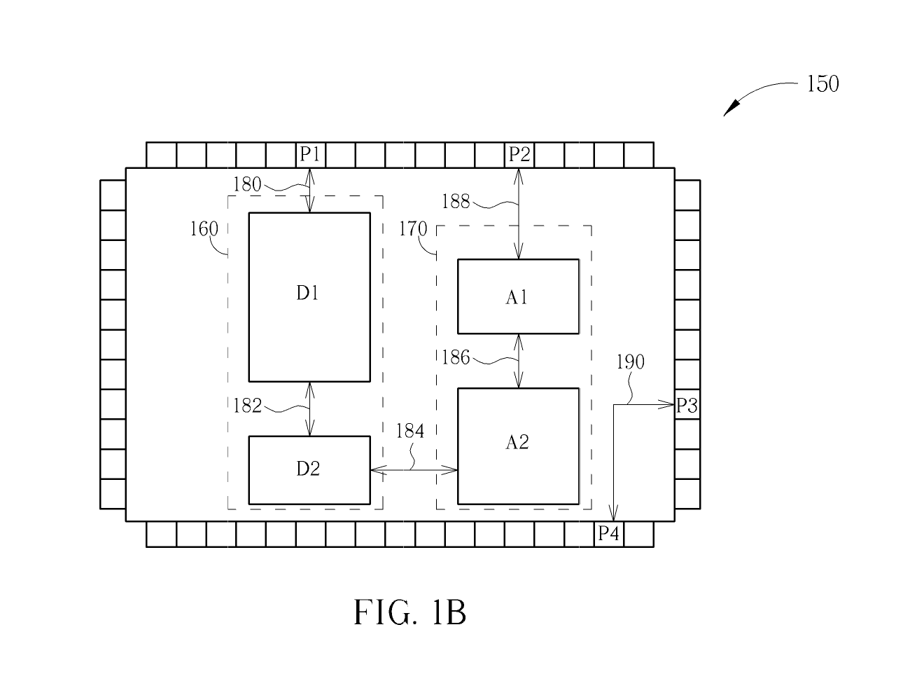

Please refer to FIG. 1A, which is a diagram illustrating a computer readable medium 120 according to one embodiment of the present invention. As shown in FIG. 1A, a computer host 100 includes a processor 110 and the computer readable medium 120, where the computer readable medium 120 includes a program code 122 and a default I/O cell library model 124. In addition, the computer readable medium 120 can be implemented by a hard disk or other storage device. The program code 122 is used to check whether a plurality of I/O cells and its directly connected block and there connecting nodes in a chip design have connection errors or not according to I/O attributes listed in the default I/O cell library model 124, and the program code 122 is also used to check whether the connecting nodes of the two connected I/O cells have connection error(s) or not. The attribute of the node of each I/O cell corresponds to at least one check items such as names (cell name, pin name), direction of input/output, voltage, current, disconnection between analog and digital. In addition, the check items of the default I/O cell library model 124 can be added or modified according to the designer's experience and the connection errors happened in the past.

For example, please refer to FIG. 1B, which is a diagram illustrating a chip design 150. As shown in FIG. 1B, the chip design 150 includes a digital circuit block 160, an analog circuit block 170 and a plurality of I/O cells including P1-P4, where the digital circuit block 160 includes two blocks D1 and D2, and the analog circuit block 170 includes two blocks A1 and A2. In addition, many connecting lines 180-190 are used to connect the blocks D1, D2, A1 and A2 and I/O cells P1-P4, where the connecting line 180 is used to connect a node of block D1 and the I/O cell P1, the connecting line 182 is used to connect nodes of the blocks D1 and D2, the connecting line 184 is used to connect nodes of the blocks D2 and A2, the connecting line 186 is used to connect nodes of the blocks A1 and A2, the connecting line 188 is used to connect a node of the block A1 and the I/O cell P2, and the connecting line 190 is used to connect the I/O cells P3 and P4. The program code 122 can check whether the connections between the I/O cells and the blocks (i.e. connecting lines 180 and 188) and the connection between the I/O cells (i.e. connecting line 190) have connection errors or not according to the check items corresponding to the attributes of the I/O cells P1-P4 listed in the default I/O cell library model 124. In addition, although the above embodiment merely shows four I/O cells P1-P4 and their connections, the program code 122 can check the I/O cells and their connections in the whole chip design 150 when the I/O cells have defined in the default I/O cell library model 124, and the program code 122 can report which nodes and which I/O cells have connection errors in a hierarchy manner.

In the embodiment shown in FIG. 1A, the default I/O cell library model 124 is stored in the computer readable medium 120, however, it is not meant to be a limitation of the present invention. In other embodiments of the present invention, the default I/O cell library model 124 can be stored in a remote storage device, and the computer host 100 can access the default I/O cell library model 124 by network connection; and the default I/O cell library model 124 can also be built in the program code 122. These alternative designs shall fall within the scope of the present invention.

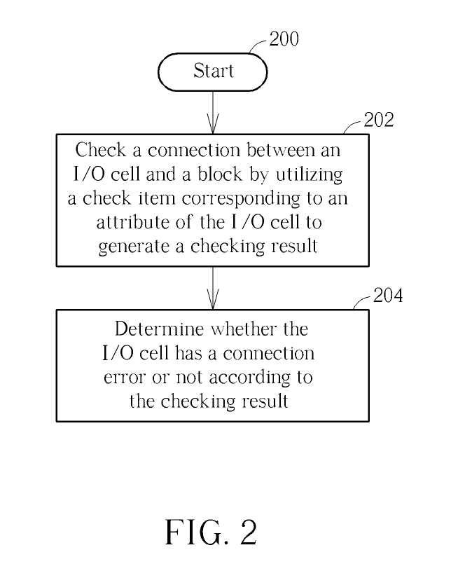

Please refer to FIG. 1A and FIG. 2 together; FIG. 2 is a flowchart of a method for checking whether the I/O cells in a chip design have connection errors or not according to one embodiment of the present invention, where the chip design includes a plurality of I/O cells and a plurality of circuit blocks. When the program code 122 is executed by the processor 110, the program code 122 executes the following steps to use the check items corresponding to the attributes of the I/O cells P1-P4 listed in the default I/O cell library model 124 to check whether the I/O cells in the chip design have connection errors or not.

In Step 200, the flow starts. Then, in Step 202, a connection between an I/O cell and a block is checked by using a check item corresponding to an attribute of the I/O cell to generate a checking result. Then, in Step 204, it is determined whether the I/O cell has a connection error according to the checking result. Finally, after checking the I/O cells in the chip design, report which I/O cell and which node of the I/O cell has connection error in a hierarchy manner.

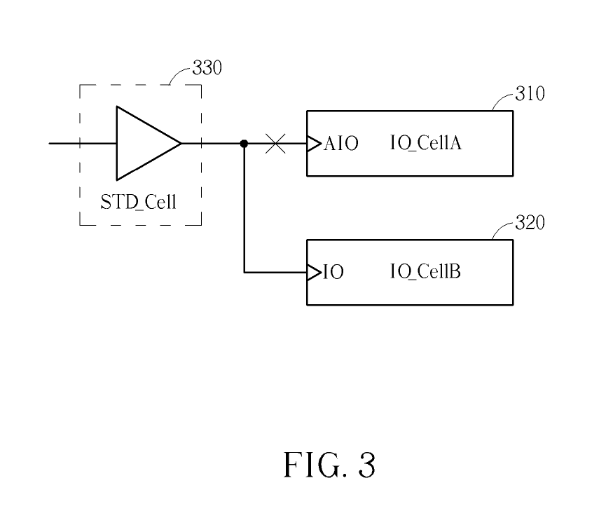

In detail, in the chip design, each I/O cell has its own cell name, each I/O cell includes at least one node, and each node has a pin name; each block has a block name, each I/O cell includes at least one node, and each node has a pin name; and the name checks of the default I/O cell library model 124 can set that the node having a specific pin name cannot connect to a block having a specific block name. For example, please refer to FIG. 3 showing an I/O cell 310 having cell name “IO_CellA”, an I/O cell 320 having cell name “IO_CellB” and a block having the block name “STD cell”. Assuming that the cell name check is set that a node having the pin name “AIO” of a specific I/O cell cannot connect to the block having the block name “STD cell”, because the node of the I/O cell 310 is connected to the block 330 having the block name “STD cell”, the checking result generated by the program code 122 will indicate this connection error, and the program code 122 will report that the node AIO of the I/O cell 310 has the connection error in a hierarchy manner. From a point of view of the attribute of the I/O cell, the node (AIO) of the analog I/O cell (analog 10 Cell) should not be connected to a standard cell (i.e. STD_Cell). Similarly, the node of the digital I/O cell should not be connected to an analog node of the block.

In addition, the cell name check of the default I/O cell library model 124 can set a rule that the node, having a specific pin name, of the I/O cells must be connected to a specific node of a specific block. If the rule is not satisfied, the checking result generated by the program code 122 will indicate this connection error, and the program code 122 will report that the node has the connection error.

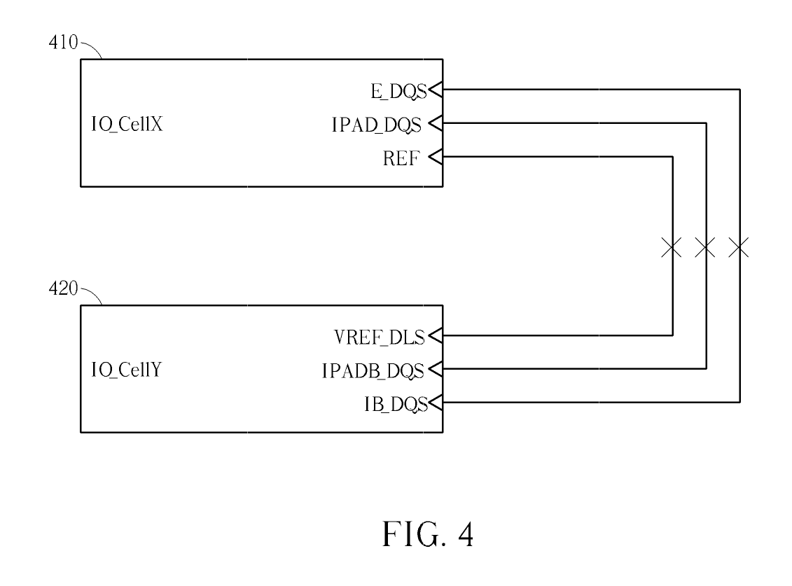

In addition, the pin name check of the default I/O cell library model 124 can set a rule that a first node having a first pin name must be directly connected to a second node having a second pin name of a second I/O cell. For example, please refer to FIG. 4 showing an I/O cell 410 having a cell name “IO_CellX” and an I/O cell 420 having a cell name “IO_CellY”, assuming that the pin name check sets a rule that the nodes having the pin names “E_DQS”, “IPAD_DQS” and “REF” must be connected to the node having the same pin names, respectively, because the nodes having the pin names “E_DQS”, “IPAD_DQS” and “REF” of the I/O cell 410 are not connected to the nodes having the same pin names, the checking result generated by the program code 122 will indicate this connection error, and the program code 122 will report that the nodes of the I/O cell 410 have the connection error. The above example is used to limit that only the nodes having the same pin name can connect to each other. The above rule may be used in a condition that the nodes of different I/O cells are connected to the same node of a block to share a signal. Similarly, the above pin name check can also be used to check whether the node of the I/O cell is connected to the node of the block having the same pin name.

In addition, when the I/O cell has a node, the block has a block node, the node of the I/O cell is directly connected to the block node, the check items may comprises an input/output direction, cell name and pin name check, and the program code 122 uses the input/output direction, cell name and pin name (i.e., node name and block node name) check to compare input/output directions of the node and the block node to generate the checking result to indicate that whether the connection is correct or not.

In addition, a node of the I/O cell of the chip design may have a current attribute, and a current attribute check of the default I/O cell library model 124 can set a rule that a node having a first current attribute must be directly connected to a node having a second current attribute. In this embodiment, the current attribute can be a specific current direction. For example, if a node of the I/O cell is an entering current of an N-type transistor (NMOS), the node of the I/O cell must be connected to a leaving current of a P-type transistor (PMOS) of another I/O cell or another block; and if a node of the I/O cell is a leaving current of a P-type transistor (PMOS), the node of the I/O cell must be connected to an entering current of an N-type transistor (NMOS) of another I/O cell or another block. If one or more nodes of the I/O cells of the chip design fail to satisfy the rule of the current attribute check of the default I/O cell library model 124, the checking result generated by the program code 122 will indicate this connection error, and the program code 122 will report that the node has the connection error.

In addition, a node of the I/O cell of the chip design may have a voltage attribute, and a voltage attribute check of the default I/O cell library model 124 can check whether an operating voltage of the node of the I/O cell is the same as an operating voltage of a node of a block including the I/O cell. If one or more nodes of the I/O cells of the chip design fail to satisfy the rule of the voltage attribute check of the default I/O cell library model 124, the checking result generated by the program code 122 will indicate this connection error, and the program code 122 will report that the node has the connection error. For example, if the operating voltage of the node of the I/O cell is 3.3V, the operating voltage of the node of the block should also be 3.3V; otherwise the program code 122 will report that the node has the connection error to prevent the node of the I/O cell operated in 3.3V from connecting to the node operated in 1.2V or other operating voltages.

In light of above, the method for checking I/O cell connections of the present invention can quickly report which nodes of I/O cells have connection errors. In addition, because the check method of the present invention is a static analysis, compared with the prior art static analysis and other dynamic analysis, the check method of the present invention does not need much manual check time, and the errors caused by manual check can be decreased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A computer readable medium comprising a program code for checking whether an I/O cell of a chip design has a connection error or not, wherein the chip design comprises a plurality of I/O cells and a plurality of blocks, and when the program code is executed by a processor, the program code executes following steps:
checking a connection between the I/O cell and a block by utilizing a check item corresponding to an attribute of the I/O cell to generate a checking result; and
determining whether the I/O cell has a connection error or not according to the checking result.

2. The computer readable medium of claim 1, wherein the I/O cell has a node, the block has a block node, the node is directly connected to the block node, the attribute is a voltage attribute, the check item comprises a voltage check, and the step of generating the checking result comprises:
utilizing the voltage check to compare operating voltages of the node and the block node to generate the checking result.

3. The computer readable medium of claim 1, wherein the I/O cell has a node, the block has a block node, the node is directly connected to the block node, the attribute comprises an input/output direction, cell name and pin name, the check item comprises an input/output direction, cell name and pin name check, and the step of generating the checking result comprises:
utilizing the input/output direction, cell name and pin name check to compare input/output directions of the node and the block node to generate the checking result.

4. The computer readable medium of claim 1, wherein the I/O cell has a node having a pin name, the block has a block node having a block pin name, the node is directly connected to the block node, the check item comprises a pin name check, and the step of generating the checking result comprises:
utilizing the pin name check to compare the pin name and the block pin name to generate the checking result.

5. The computer readable medium of claim 1, wherein the I/O cell has a node having a pin name, the block has a block name, the node is directly connected to the block, the check item comprises a pin name check, and the step of generating the checking result comprises:
utilizing the pin name check to compare the pin name and the block name to generate the checking result.

6. The computer readable medium of claim 1, wherein the I/O cell has a node having a pin name, the block has a block node, the node is directly connected to the block node, the attribute is a current attribute, the check item comprises a current attribute check, and the step of generating the checking result comprises:
utilizing the current attribute check to compare current directions of the node and the block node to generate the checking result.

7. The computer readable medium of claim 1, wherein the step of generating the checking result further comprises:
checking a connection between a first I/O cell and a second I/O cell by utilizing a first check item corresponding to a first attribute of the first I/O cell to generate the checking result.

8. A method for checking whether an I/O cell of a chip design has a connection error or not, wherein the chip design comprises a plurality of I/O cells and a plurality of blocks, and the method comprises:
executing a program code to check a connection between the I/O cell and a block by utilizing a check item corresponding to an attribute of the I/O cell to generate a checking result; and
determining whether the I/O cell has a connection error or not according to the checking result.

9. The method of claim 8, wherein the I/O cell has a node, the block has a block node, the node is directly connected to the block node, the attribute is a voltage attribute, the check item comprises a voltage check, and the step of generating the checking result comprises:
utilizing the voltage check to compare operating voltages of the node and the block node to generate the checking result.

10. The method of claim 8, wherein the I/O cell has a node, the block has a block node, the node is directly connected to the block node, the attribute comprises an input/output direction, cell name and pin name, the check item comprises an input/output direction, cell name and pin name check, and the step of generating the checking result comprises:
utilizing the input/output direction, cell name and pin name check to compare input/output directions, cell name and pin name of the node and the block and node to generate the checking result.

11. The method of claim 8, wherein the I/O cell has a node having a pin name, the block has a block node having a block pin name, the node is directly connected to the block node, the check item comprises a pin name check, and the step of generating the checking result comprises:
utilizing the pin name check to compare the pin name and the block pin name to generate the checking result.

12. The method of claim 8, wherein the I/O cell has a node having a pin name, the block has a block name, the node is directly connected to the block, the check item comprises a pin name check, and the step of generating the checking result comprises:
utilizing the pin name check to compare the pin name and the block name to generate the checking result.

13. The method of claim 8, wherein the I/O cell has a node having a pin name, the block has a block node, the node is directly connected to the block node, the attribute is a current attribute, the check item comprises a current attribute check, and the step of generating the checking result comprises:
utilizing the current attribute check to compare current directions of the node and the block node to generate the checking result.

14. The method of claim 8, wherein the step of generating the checking result further comprises:
checking a connection between a first I/O cell and a second I/O cell by utilizing a first check item corresponding to a first attribute of the first I/O cell to generate the checking result.
